(19) United States
(12) Patent Application Publication
(10) Pub. No.: US 2014/0203643 A1
(43) Pub. Date: Jul. 24, 2014

(54) Energy Harvesting Scheme

(71) Applicant: Ryuji Maeda, San Diego, CA (US)

(72) Inventor: Ryuji Maeda, San Diego, CA (US)

(21) Appl. No.: 13/747,355

(22) Filed: Jan. 22, 2013

(51) Int. Cl. H02J 4/00

(52) U.S. Cl. CPC H02J 4/00
USPC 307/43; 290/1 R

(57) ABSTRACT

A system adapted to generate, collect and store electrical energy is described. The system includes: a set of sources; each source in the set adapted to generate heat energy, convert the generated heat energy into electrical energy, and store the electrical energy; and a set of reservoirs, each reservoir in the set adapted to receive the stored electrical energy from at least one source in the set of sources and store the received energy. A device adapted to convert heat from a source into electrical energy is also described. The device includes: a connection to at least two elements of the source, wherein the at least two elements provide a temperature differential; a thermo-electric generator (TEG) adapted to convert the temperature differential into electrical energy; and an energy storage module adapted to receive electrical energy from the TEG and store the received energy.

### BACKGROUND

Energy consuming devices are ubiquitous in society. In addition, many heat-producing systems, devices, components, etc. are producing energy in the form of heat that is typically not recovered (i.e., the heat energy is simply dissipated). Such heat energy, which may be produced in relatively small quantities by individual devices, may cumulatively provide significant amounts of energy for various uses.

Thus there is a need for a way to harvest energy generated by existing thermal sources, convert, and accumulate the energy such that the energy may be made available to power various loads.

### BRIEF SUMMARY

Some embodiments of the invention generally provide a way to harvest energy from a set of sources and provide the energy to a set of loads. Sources may include any element capable of generating heat. Loads may include any systems, devices, components, etc., that are able to utilize electric energy.

Some embodiments may provide small-scale energy harvesting systems (e.g., for homes, shops (e.g., cafés, gas stations, etc.), electric car charging stations, etc.). In some of these embodiments, the systems may not be intended to couple to any external systems (e.g., a power grid), but would be used to provide power to a small-scale establishment or a sub-element thereof.

Medium to large-scale energy harvesting systems (e.g., for city street lights, government buildings, etc.) may be provided by some embodiments. Such systems may typically couple to a power grid.

In some embodiments, energy trading may be monitored, controlled, and/or otherwise facilitated. For instance, a user may receive credit for supplied energy and thereby receive a benefit (e.g., a reduction to a monthly utility bill, an energy donation to a school, hospital or charity, etc.). Some such embodiments may integrate with one or more networking sites to monitor, report, share, and/or otherwise utilize these user activities.

A first exemplary embodiment of the invention provides a system adapted to generate, collect and store electrical energy. The system includes: a set of sources; each source in the set adapted to generate heat energy, convert the generated energy into electrical energy, and store the electrical energy; and a set of reservoirs, each reservoir in the set adapted to receive the stored electrical energy from at least one source in the set of sources and store the received energy.

Another exemplary embodiment of the invention provides a device adapted to convert heat from a source into electrical energy. The device includes: a connection to at least two elements of the source, wherein the at least two elements provide a temperature differential; a thermo-electric generator (TEG), also known as a “Seebeck generator”, adapted to convert the temperature differential into electrical energy; and an energy storage module adapted to receive electrical energy from the TEG and store the received energy.

Still another exemplary embodiment of the invention provides a device adapted to receive transmitted electrical or electromagnetic energy from a set of sources. The device includes: a receiver array adapted to receive the transmitted energy from at least one source in the set of sources; and an energy storage element adapted to store the energy received by the receiver array.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGS.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a conceptual energy harvesting system according to an exemplary embodiment the invention;

FIG. 2 illustrates a top view of an example usage scenario of some embodiments;

FIG. 3 illustrates a top view of an alternative example usage scenario of some embodiments;

FIG. 4 illustrates a schematic block diagram of a conceptual source sub-system of some embodiments;

FIG. 5 illustrates a schematic block diagram of a conceptual reservoir sub-system of some embodiments;

FIG. 6 illustrates a schematic block diagram of a receiver array used by some embodiments of the reservoir of FIG. 5;

FIG. 7 illustrates a schematic block diagram of an alternative connection scheme used by some embodiments;

FIG. 8 illustrates a schematic block diagram of another alternative connection scheme used by some embodiments;

FIG. 9 illustrates a schematic block diagram of yet another alternative connection scheme used by some embodiments;

FIG. 10 illustrates a schematic block diagram of still another alternative connection scheme used by some embodiments;

FIG. 11 illustrates a schematic block diagram of a distributed system provided by some embodiments;

FIG. 12 illustrates a flow chart of a conceptual process used by some embodiments to control source operation;

FIG. 13 illustrates a flow chart of a conceptual process used by some embodiments to control reservoir operation;

FIG. 14 illustrates a flow chart of a conceptual process used by some embodiments to monitor and/or control overall system operation;

FIG. 15 illustrates a flow chart of a conceptual process used by some embodiments to allow a third party to interact with the system of some embodiments; and

FIG. 16 conceptually illustrates a schematic block diagram of a computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a way of accumulating energy among multiple sources. Such sources may then provide the accumulated energy to various reservoirs and/or loads at various appropriate times. Such sources, reservoirs, loads, and/or other appropriate elements may be able to communicate and/or interact in various appropriate ways such that the use of accumulated energy may be optimized across a matrix of appropriate factors.

Several more detailed embodiments of the invention are described in the sections below. Section I provides a conceptual description of a system architecture used by some embodiments. Section II then describes a monitor and control software architecture used by some embodiments. Next, Section III describes various methods of operation used by some embodiments. Lastly, Section IV describes a computer system which implements some of the embodiments of the invention.

### I. System Architecture

Sub-section I.A provides a conceptual overview of the system and methods provided by some embodiments. Sub-section I.B then describes an exemplary source collection sub-system of some embodiments. Next, sub-section I.C describes a reservoir collection sub-system of some embodiments. Lastly, sub-section I.D describes several alternative connection schemes among sources and reservoirs.

A. Overview

Various systems implemented by some embodiments may allow a set of sources to accumulate energy which may then be provided to various available reservoirs which, in turn, may provide stored energy to one or more loads and/or power grids.

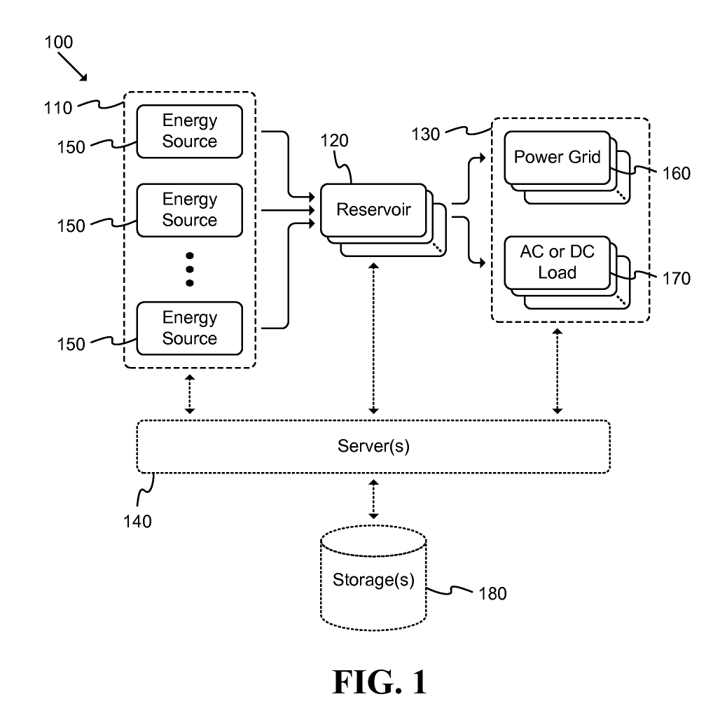

FIG. 1 illustrates a schematic block diagram of a conceptual energy harvesting system 100 according to an exemplary embodiment the invention. Specifically, this figure shows the interaction among the various system elements. As shown, the system may include a set of energy sources 110, at least one reservoir 120 adapted to store electrical energy, a set of loads 130, and at least one server 140. The set of energy sources 110 may include at least one energy source 150 and the set of loads 130 may include at least one power grid 160 and/or at least one AC and/or DC load 170. In addition, the system 100 may include at least one storage 180.

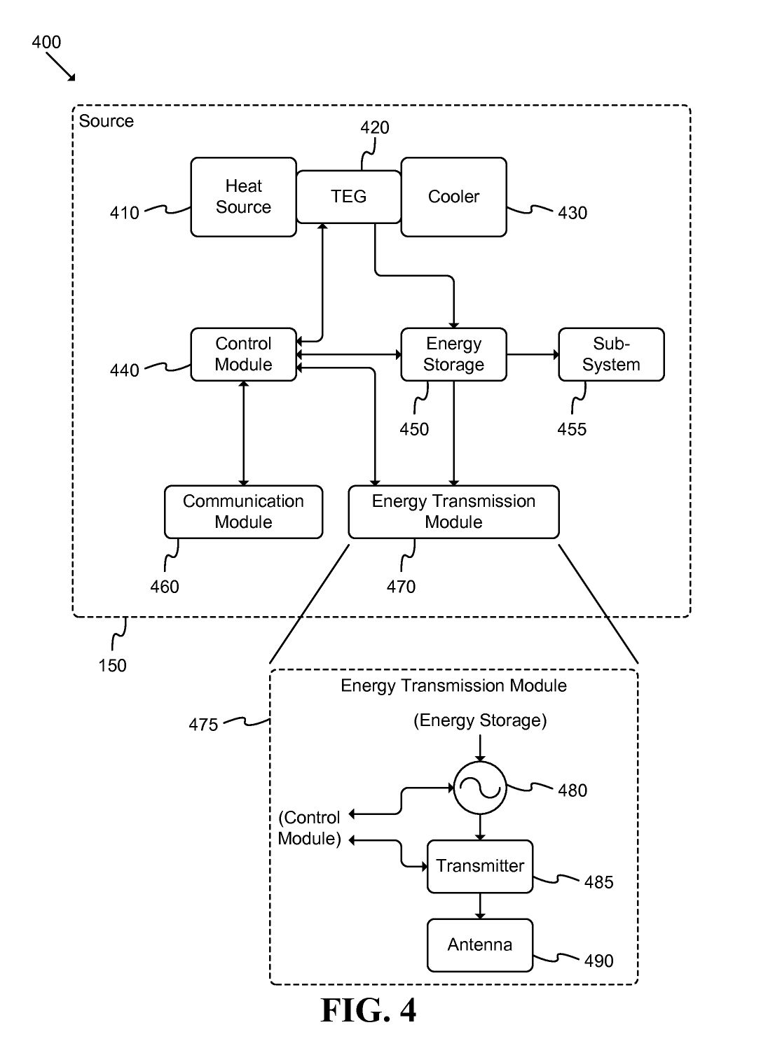

Each energy source 150 in the set 110, may be any device, component, etc. that may be capable of converting heat (i.e., a temperature difference supplied to the source) to electrical energy. Heat sources may include, for example, motor vehicles (e.g., providing a temperature difference between an engine block and external air), boats, airplanes, solar energy, wood stove, electrical appliances, etc. Sources will be described in more detail in reference to FIG. 4 below.

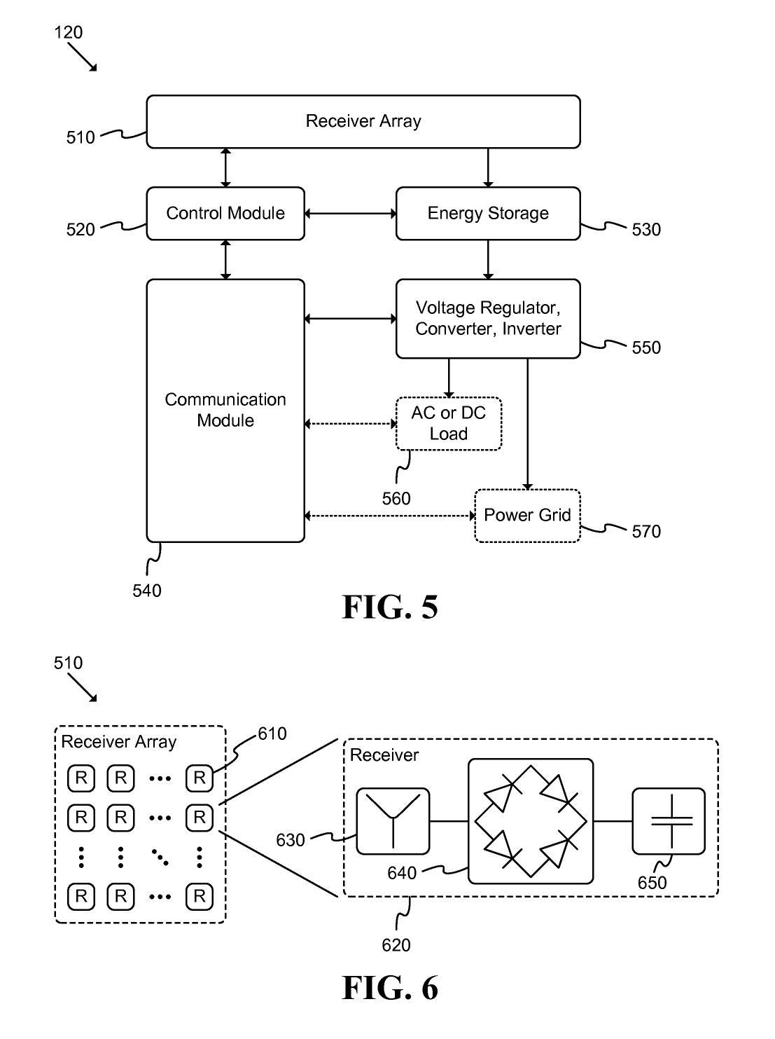

Each reservoir 120 may include a set of components that is able to receive electrical or electromagnetic energy from a source and store the received or converted electrical energy (and/or provide the received electrical energy to a load). Each reservoir may receive electrical or electromagnetic energy from a source in various appropriate ways (e.g., a hardwired connection, a wireless connection, delivery of an energy storage element such as a battery, etc.). Each reservoir may be placed at a strategic location (e.g., an intersection, airport, harbor, freeway, etc.) where heat generating sources may typically congregate and/or pass within an appropriate distance. Such electrical energy reservoirs will be described in more detail in reference to FIG. 5 below.

Each load from the set of loads 130 may be any device, component, etc. that is capable of utilizing electric energy. Such a load may be a power grid 160 and/or an AC and/or DC load 170. Different embodiments may connect to the different loads in various appropriate ways (e.g., a hardwired connection, a wireless connection, delivery of an energy storage element such as a battery, etc.). For example, the accumulated electrical energy in reservoir 120 may be transferred to an electric vehicle via a wireless charging scheme.

The server(s) 140 may include one or more devices or components that are able to send and receive data and/or instructions and process data and/or instructions (e.g., one or more personal computers (PCs)). Each storage 180 may include one or more devices or components that is able to store data and/or instructions and/or receive (and/or send) data and/or instructions among a set of devices or components that is able to connect to the storage (e.g., through one or more hardwired and/or wireless networks, networks of networks, etc.). In some embodiments (e.g., a local energy harvesting system), the server 140, storage 180, and/or other elements may be provided in conjunction with a reservoir 120 as a stand-along system.

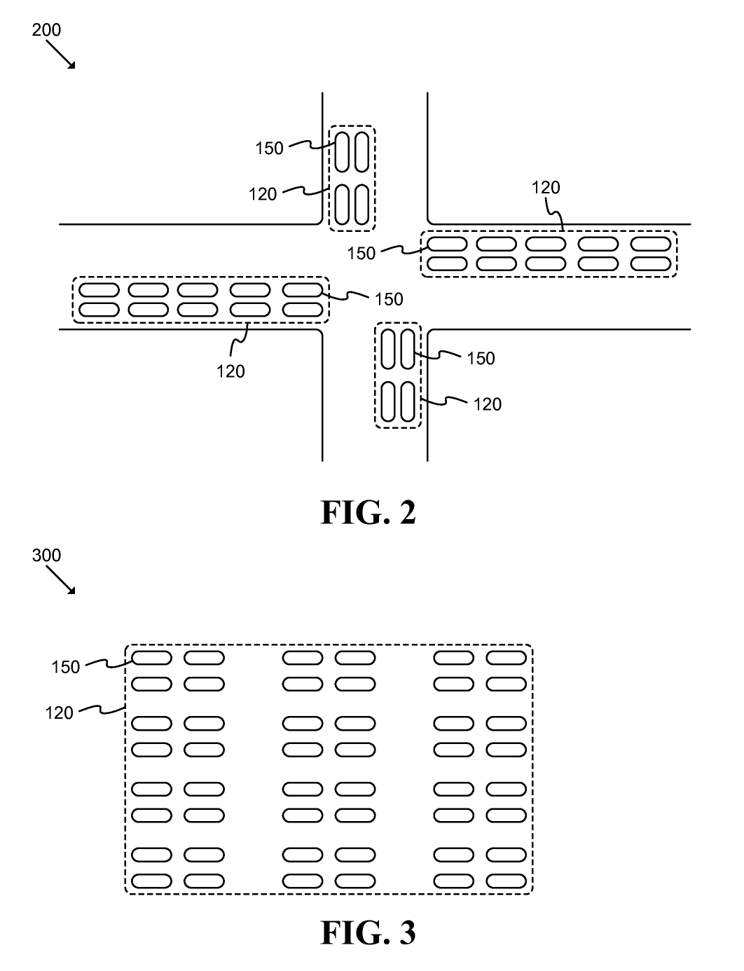

FIG. 2 illustrates a top view of an example usage scenario 200 of some embodiments. Specifically, this figure shows an example where the sources are motor vehicles and the reservoirs are located about an intersection. As shown, the scenario includes a set having multiple sources 110 and multiple reservoirs 120 (or receivers). Different embodiments may facilitate user of different numbers of sources and/or reservoirs in various different configurations.

In this example, various reservoirs 120 are located close to a stopping or slowing point along a travel route (e.g., a red light, stop sign, etc.). The reservoirs may be sized appropriately for the expected amount of traffic at the particular point along the route. Each reservoir may be able to receive energy from the set of sources 110 that are within a particular range of the reservoir. In some embodiments, each reservoir 120 may provide a beacon signal (and/or other appropriate communication) that alerts each source 150 that the reservoir is available to receive stored energy. Each reservoir 120 may be able to communicate among various sources, sources, and/or loads as will be described in more detail in reference to FIG. 5 below. Each source that is within range of a reservoir 120 may transmit (and/or otherwise provide) any available stored energy such that the reservoir is able to receive the energy. The reservoirs of this example may include various antennas, couplers, inductors, and/or other appropriate elements that are able to receive energy from a set of sources 110 that is within a threshold range of the reservoir 120.

FIG. 3 illustrates a top view of an alternative example usage scenario 300 of some embodiments. In this example, a single reservoir 120 may collect energy from multiple sources 110 that may be within range of the reservoir 120. For instance, such a reservoir may be used to collect energy from vehicles (e.g., boats, airplanes, etc.) that are typically expected to congregate within a particular region (e.g., a harbor, marina, airport, etc.). Alternatively, each reservoir may be able to collect energy from moving vehicles (e.g., cars moving along a freeway, flying planes, etc.). As another example, such a reservoir may be able to collect energy from appliances (e.g., ovens) located in homes and/or businesses throughout a community. In some embodiments, a reservoir may be mobile and may collect energy from stationary energy sources.

During operation, the system 100 may operate in various appropriate ways depending on the particular circumstances of the system and the environment of the system. For instance, in some embodiments, each source may continuously transmit energy (when available) and the reservoir may continuously receive the transmitted energy. Alternatively, in some embodiments, each source may accumulate energy in one or more localized energy storage element(s) until a threshold value is reached, at which point the energy may be transmitted. Such energy may, in some embodiments, only be transmitted when a reservoir is known to be within transmission range (e.g., based on a received beacon signal, location information, etc.). As another example, energy may be transmitted when a user makes a selection or otherwise manifests an intention to engage energy transmission.

One of ordinary skill in the art will recognize that the system 100 and examples 200-300 described above may be implemented in various different ways without departing from the spirit of the invention. For instance, different embodiments may utilize reservoirs that span different regions, as appropriate. As another example, different embodiments may utilize different types of sources that may be available in different types of locations.

B. Source Collection Sub-System

Some embodiments may provide a source collection sub-system, such that energy may be efficiently gathered and stored from an available source. Such stored energy may be provided to one or more external elements (e.g., a reservoir of some embodiments).

FIG. 4 illustrates a schematic block diagram of a conceptual source sub-system 400 of some embodiments. Specifically, this figure shows the use of an existing heat source to generate electrical energy that may be stored and/or provided to internal and/or external elements, as appropriate. As shown, the sub-system 400 may include an energy source 150 that has a heat source 410, a thermo-electric generator (TEG) 420, a cooler 430, a control module 440, an energy storage element 450, a source sub-system 455, a communication module 460, and an energy transmission module 470. An example energy transmission module is shown in section 475 and may include an oscillator 480, a transmitter 485, and an antenna 490. In some embodiments, various components of the system 400 (e.g., communication module 460) may be powered by an external energy source such as a battery.

Each energy source 150 may be any appropriate heat-generating source (e.g., a car, motorcycle, plane, boat, etc.) that has a heat source 410 (e.g., an engine block, an exhaust system, etc.), a thermo-electric generator (TEG) 420, and a cooler 430 (e.g., a radiator, external air flow, water, etc.). The TEG 420 may generate an electrical output based on a difference in temperature between the heat source 410 and the cooler 430.

The control module 440 may include various electronic and/or software components that may be used to monitor and/or control various operations of elements and/or sub-systems of the energy source 150, as appropriate.

The energy storage element 450 may be any component and/or set of components that is able to store electrical energy (e.g., a capacitor, a battery, etc.). The energy storage element may include one or more switching elements (electrical and/or mechanical) that are able to be controlled by the control module 440 in order to allow the energy storage component(s) to efficiently accumulate electrical energy and avoid undesired dissipation of the electrical energy. The source sub-system 455 (each source may include multiple such sub-systems) may be any sub-system of the source that requires electric power (e.g., lights, communication systems, entertainment systems, air-condition systems, etc.).

The communication module 460 may be adapted to communicate among various external systems and/or resources (e.g., one or more energy reservoirs 120) across one or more communications pathways (e.g., wired connections, wireless connections, network connections, networks of network connections, etc.).

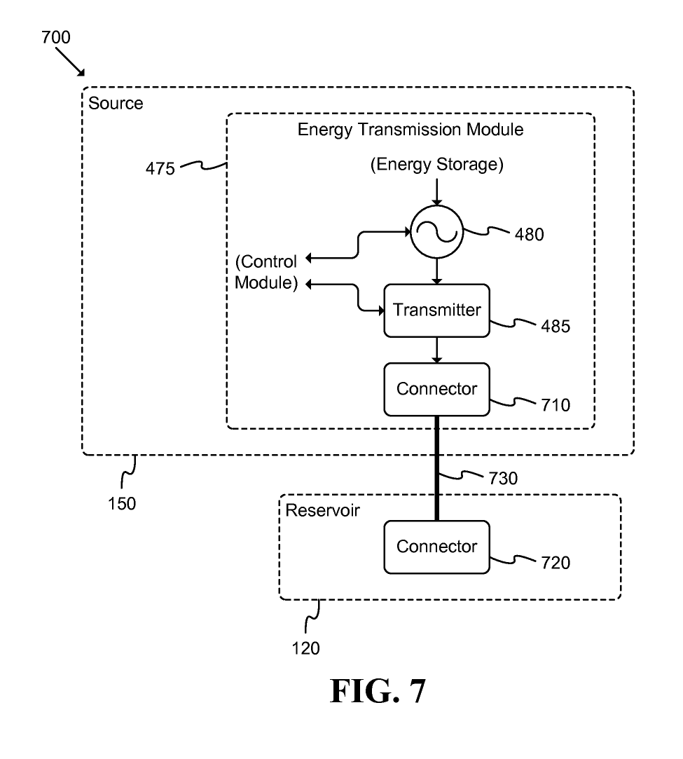

The energy transmission module 470 may include various components that are able to transfer stored energy to an external system or component. Various alternative energy transmission modules are described below in reference to FIGS. 7-10.

As shown, one example energy transmission module 475 may include an oscillator 480, a transmitter 485, and an antenna 490. Such an oscillator 480 may be able to convert stored energy into a repeating signal (e.g., a sinusoid, a square wave, etc.). Such a transmitter 485 may be able to receive the repeating signal and provide the signal to a transmitting element such as antenna 490. Examples of transmitter 485 include a fixed gain amplifier, a variable gain amplifier (VGA), and a buffer. The transmitter may include an impedance matching network or stage at its input and/or output. The antenna 490 may, in turn, be able to broadcast the signal to one or more appropriate receivers. Alternatively, the antenna may be connected directly to an output of the oscillator 480 without including a transmitter stage.

During operation, the TEG 420 may continuously generate energy which may be stored, in turn, by the energy storage element 450. The energy storage element may, in turn, make the stored energy available to one or more sub-systems 455 (e.g., vehicle sub-systems, establishment sub-systems, etc.) and/or the energy transmission module 470. Such stored energy may be made available based on various appropriate criteria (e.g., a minimum threshold of stored energy, a proximity to a receiving reservoir, etc.). In addition, during operation, the communication module 460 may send and/or receive data and/or instructions from various external elements and/or systems. In some embodiments, the energy transmission module 470 may transmit energy to an external resource (e.g., a reservoir), as appropriate. Such energy transmission may be based on various appropriate factors (e.g., amount of stored energy, proximity of the reservoir, etc.).

In one particular example, the energy transmission module 475 may receive stored energy and provide the energy to an oscillator 480 which, in turn, provides the output waveform to a transmitter 485 that transmits the energy through an antenna 490. Such energy may be transmitted as, for example, space propagating microwave signals that may be able to be received by a reservoir and converted into DC electric energy (e.g., using a rectenna). Such microwave energy may alternatively be transmitted through a coaxial cable or waveguide, if appropriate (e.g., in applications such as home energy collection where a vehicle may be parked in a set location such as a garage, a docked boat, etc.).

One of ordinary skill in the art will recognize that system 400 has been described with reference to various specific details. However, different embodiments may be implemented in various different ways without departing from the spirit of the invention. For instance, different transmission schemes may be used. As another example, different embodiments may include different types of sources and/or reservoirs.

C. Reservoir Collection Sub-System

Some embodiments may provide a reservoir collection sub-system, such that energy may be efficiently gathered and stored from multiple sources. Such stored energy may be provided to one or more external elements (e.g., one or more external loads of some embodiments).

FIG. 5 illustrates a schematic block diagram of a conceptual reservoir sub-system 120 of some embodiments. Specifically, this illustration shows various components and/or communication pathways that may be included in a collection system of some embodiments. As shown, the system 120 may include a receiver array 510, a control module 520, an energy storage element 530, a communication module 540, a voltage regulator, converter, and/or inverter 550, an AC or DC load 560, and a power grid 470. In some embodiments, one or more of the components of the sub-system 120 (e.g., communication module 540) may be powered by an external energy source such as a battery and/or a power grid.

The receiver array 510 may include one or more receiving elements (e.g., antennas, rectennas, detectors, couplers, inductors, resonators, etc.) that may be adapted to receive electrical or electromagnetic energy transmitted from one or more sources. In some embodiments, each source may transmit microwave energy through space that is able to be received by an appropriate set of antennas and converted into electrical energy. Alternatively, each source may transmit microwave energy through a cable that is able to be received by an appropriate set of rectifiers and converted into electrical energy. As another example, each source may transfer energy that is able to be received by an appropriate set of electromagnetic induction devices. The receiver array may be able to receive signals across a region that may be defined in various appropriate ways (e.g., power and spread of a single antenna, arrangement and/or control of an array of antennas, etc.).

The control module 520 may be adapted to send and/or receive communications (e.g., data and/or instructions) from (and/or to) various other system elements, as appropriate. The control module may be adapted to monitor and/or control various operations of the components of the source 120.

The energy storage element 530 may be adapted to store energy such that the energy may be made available to various internal and/or external resources. The energy may be stored in various appropriate ways and/or forms (e.g., stored using a super capacitor, a battery, etc.). The energy storage element may include one or more switching elements (electrical and/or mechanical) that are able to be controlled by control module 520 in order to allow the energy storage component(s) to efficiently accumulate electrical energy and avoid undesired dissipation of the electrical energy. The communication module 540 may be adapted to communicate among various internal and/or external sub-elements (e.g., communication module 460 described above) across various appropriate mediums (e.g., one or more cables, networks, networks of networks, etc.).

The voltage regulator, converter, and/or inverter 550 may include various elements that are able to convert the stored energy from energy storage 530 into energy that is usable by external AC or DC loads 560 and/or one or more power grids 570. In some embodiments, bidirectional converters which allow power transfer from external sources (e.g. a power grid) to energy storage element 530 may be used, as appropriate.

Each AC or DC load 560 may include various components, elements, systems, etc. that require AC or DC power. Each load 560-570 may include one or more connections, interfaces, etc. that may allow the reservoir 500 to be connected to the load. Each load 560-570 may be adapted to communicate with the communication module 540 and/or control module 520 (connection not shown), as appropriate.

During operation, the receiver array 510 may continuously (and/or based on various criteria) receive energy which may be stored, in turn, by the energy storage element 530. The energy storage element may, in turn, make the stored energy available to the voltage regulator, converter and/or inverter 550 which may, in turn, make the energy available to one or more AC and/or DC loads 560 and/or power grids 570 based on various appropriate criteria (e.g., a minimum threshold of stored energy, demand of a load, etc.). In addition, during operation, the communication module 540 may send and/or receive data and/or instructions from various external elements and/or systems (e.g., the communication module 460 described above in reference to FIG. 4).

FIG. 6 illustrates a schematic block diagram of a receiver array 510 used by some embodiments of the reservoir 120. Specifically, this figure shows a conceptual arrangement of receivers and associated circuitry used by some embodiments. As shown, the array 510 may include one or more receivers 610 which may be arranged in various appropriate ways (e.g., each receiver may be sized, positioned, aligned, etc. in a particular way for a particular application based on one or more parameters associated with the system and/or other receivers used by the system).

As shown in exploded view 620, each receiver 610 may include one or more antennas 630, a rectifying component 640, and a low pass filter 650. Such a receiver may be referred to as a “rectenna” (or a “rectifying antenna”). Each antenna 630 may be adapted to receive a signal from an appropriate transmitter (e.g., a signal transmitted from antenna 490 described above in reference to FIG. 4). The rectifying component 640 may include various components that are able to rectify electrical energy received from the antenna 630. The low pass filter 650 may include various appropriate components that filter the output of the rectifying component 640. In some embodiments, energy storage element 530 described above in reference to FIG. 5 may act as a low pass filter (e.g., when the element includes a capacitor). In addition, each receiver 610 may include an energy storage element (not shown) such as a battery, capacitor, etc.

One of ordinary skill in the art will recognize that systems 500-600 have been described with reference to various specific details, however, different embodiments may be implemented in various different ways without departing from the spirit of the invention. For instance, different transmission schemes may be used. As another example, different embodiments may include different types of sources and/or reservoirs.

D. Connection Schemes

FIGS. 7-10 illustrate various connection schemes that may be used in conjunction with, or in place of, the connection schemes of FIGS. 4-6. The type of connection scheme used may be based on various appropriate considerations (e.g., type of source, energy produced by the source, transmission range of the source, receiving range of the reservoir, etc.).

FIG. 7 illustrates a schematic block diagram of an alternative connection scheme 700 used by some embodiments. Specifically, this figure shows a cabled connection (e.g., a coaxial cable connection) used to transmit an oscillating signal (e.g., a microwave signal). As shown, the scheme 700 may include a first connector 710 associated with the source 150 and a second connector 720 associated with the reservoir 120. The first connector 710 and second connector 720 may be coupled using an appropriate cable 730.

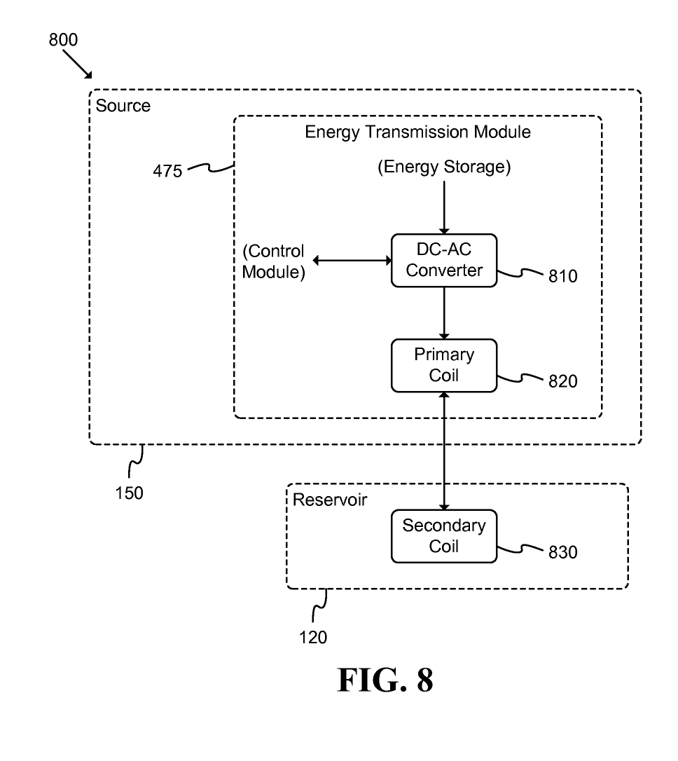

FIG. 8 illustrates a schematic block diagram of another alternative connection scheme 800 used by some embodiments. Specifically, this figure shows an inductively coupled configuration used by some embodiments. As shown, the scheme 800 may include a DC to AC converter 810, a primary coil 820 associated with the source 150, and a secondary coil 830 associated with the reservoir 120.

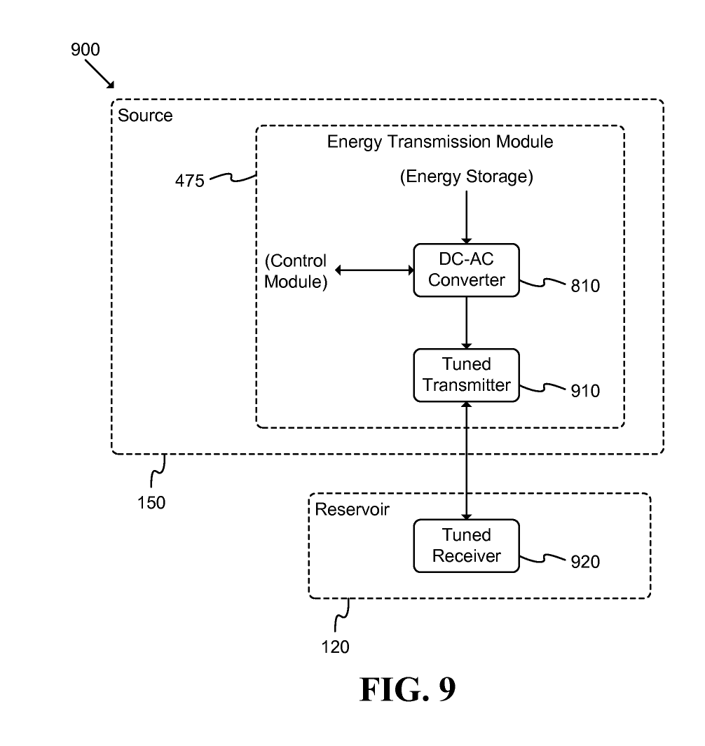

FIG. 9 illustrates a schematic block diagram of yet another alternative connection scheme 900 used by some embodiments. Specifically, this figure shows a resonant coupling configuration used by some embodiments. As shown, the scheme 900 may include a DC to AC converter 810, a tuned (e.g., using an LC circuit) transmitter 910 associated with the source 150, and a tuned (e.g., using an LC circuit) receiver 920 associated with the reservoir 120.

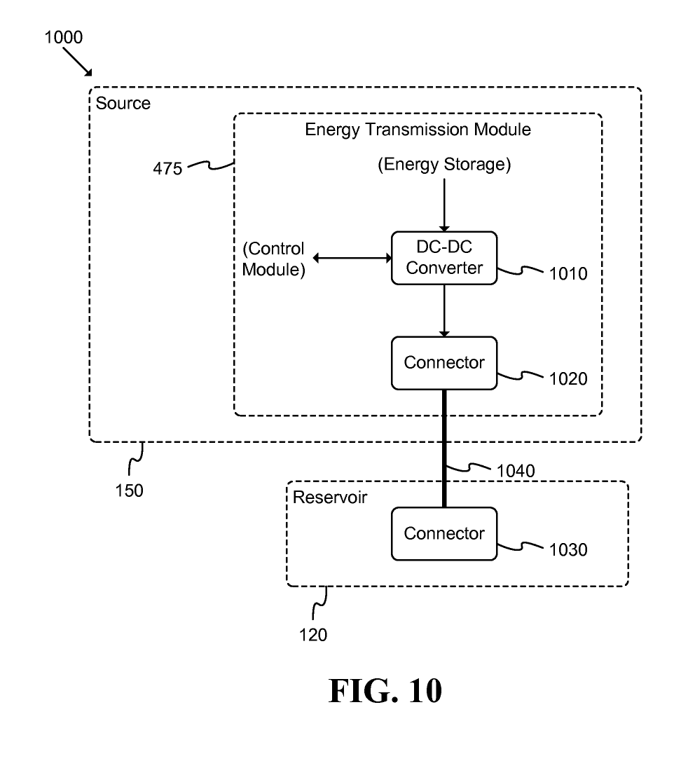

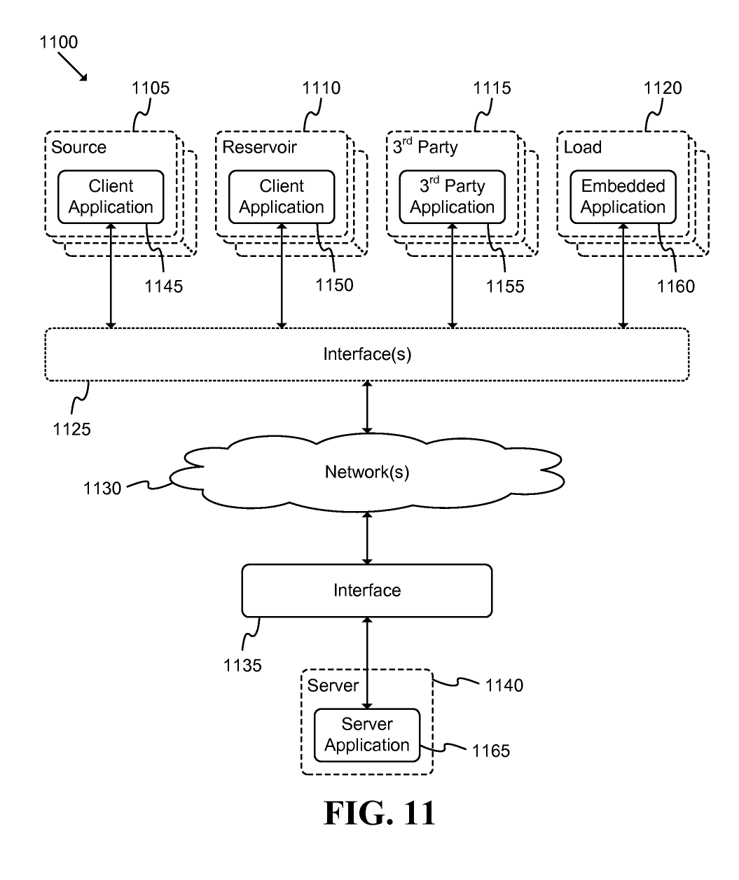

FIG. 10 illustrates a schematic block diagram of still another alternative connection scheme 1000 used by some embodiments. Specifically, this figure shows a DC to DC coupled configuration used by some embodiments. As shown, the scheme 1000 may include a DC to DC converter 1010, a first connector 1020 associated with the source 150, a second connector 1030 associated with the reservoir 120, and a connection cable 1040 coupling the first and second connectors 1020-1030.

Although the various schemes of FIGS. 7-10 have been described with reference to various specific details, one of ordinary skill in the art will recognize that the schemes may be implemented in various different ways without departing from the spirit of the invention. For instance, various different elements, communications pathways and/or interfaces may be used in different embodiments, as appropriate.

### II. Monitor and Control Architecture

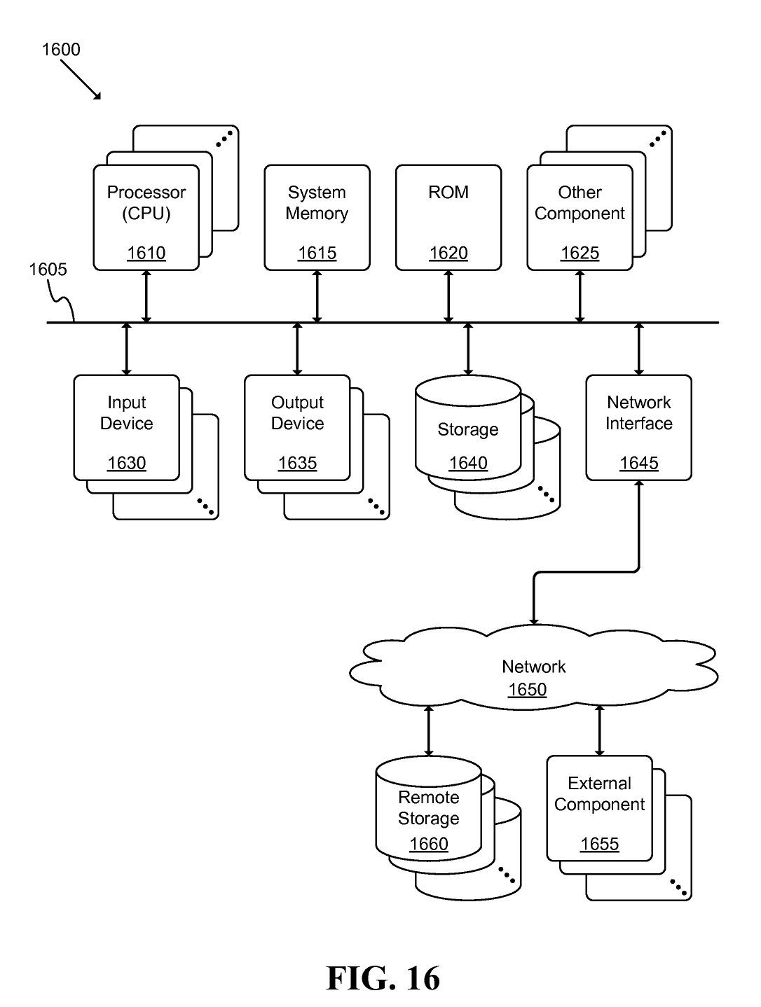

Some embodiments provide a distributed control architecture that may be utilized among multiple devices and/or parties, as appropriate. Such a distributed architecture may facilitate various data collection and analysis endeavors, optimized control of energy accumulation, etc. Various elements of the system described below may be implemented using software and/or electronic components. One example system that may allow such features will be described below in reference to FIG. 16.

FIG. 11 illustrates a schematic block diagram of a distributed system 1100 provided by some embodiments. Specifically, this figure shows various software elements that may be used by some embodiments. As shown, the system may include at least one source 1105, at least one reservoir 1110, at least one third party 1115, at least one load 1120, one or more interfaces 1125, one or more networks 1130, at least one remote interface 1135, and at least one server 1140. Each client element 1105-1120 may execute an associated client application 1145-1160 and the server 1140 may execute a server application 1165.

Each source 1105 may be similar to that described above in reference to FIG. 4. A source may execute a client application 1145 that may be able to process various instructions and/or manipulate various data elements. The client application of some embodiments may allow the source to send and receive instructions and/or data among other elements of the system.

Each reservoir 1110 may be similar to that described above in reference to FIG. 5. A reservoir may execute a client application 1150 that may be able to process various instructions and/or manipulate various data elements. The client application of some embodiments may allow the reservoir to send and receive instructions and/or data among other elements of the system.

In some embodiments, client application 1145 may be able to communicate directly with (and/or monitor, and/or control) client application 1150 and vice-versa (e.g., using the various connection schemes described above reference to FIGS. 7-10). Various physical layer protocols known in the art, such as Bluetooth or any other proprietary communication protocols may be used. In some embodiments, data may be transmitted using the repeating signal generated from the oscillator 480 described above in reference to FIG. 4 as the carrier signal.

Returning to FIG. 11, each third party 1115 may be, for instance, a personal computer (PC), smartphone, tablet device, etc. Such a device may be associated with one or more users and/or user accounts. A third party may execute a client application 1155 that may be able to process various instructions and/or manipulate various data elements. The client application of some embodiments may allow the third party to send and receive instructions and/or data among other elements of the system.

Each load 1120 may be any device that is capable of using stored electrical energy. A load may execute a client application 1160 that may be able to process various instructions and/or manipulate various data elements. The client application of some embodiments may allow the load to send and receive instructions and/or data among other elements of the system.

Each interface 1125 may be associated with one or more device types, communication protocols, pathways, and/or algorithms, etc. Such interfaces may include, for example, wired and/or wireless network connections, cellular network elements, application programming interfaces (APIs), etc. The interfaces may allow the various disparate elements 1105-1120 to access one or more networks 1130. Each remote interface 1135 may allow the network(s) 1130 to be accessed by the server(s) 1140 which may execute a server application 1165. The server application of some embodiments may allow the server to send and receive instructions and/or data among other elements of the system.

In some embodiments, third party developers may access the server 1140 using an API. Such access may allow the third party developers to utilize system information regarding sources, reservoirs, loads, etc.

As an example usage scenario, some embodiments may allow a third party (e.g., an energy supplier such as an electric utility) to monitor sources associated with customers of the third party. The customer may then be rewarded for depositing a minimum threshold of energy with a specified reservoir, for instance. As another example, a third party owner of multiple reservoirs (or a public or government entity associated with the reservoirs) may monitor usage at the reservoirs to optimize energy accumulation (e.g., by expanding the receiving area of highly used reservoirs, by providing a beacon signal only at relatively high periods of usage, etc.).

### III. Methods of Operation

Sub-section IIL.A provides a conceptual description of a process executed by the source of some embodiments. Sub-section III.B then describes a conceptual process executed by the reservoir of some embodiments. Lastly, sub-section III.C describes several conceptual processes executed by the server of some embodiments.

A. Source

Various types of sources may implement various specific algorithms during use. For instance, automobiles such as taxis that are mainly operated in metropolitan areas may continuously transmit energy, expecting that a reservoir is usually within receiving distance. As another example, sources in rural areas may accumulate energy until a reservoir associated with the source reaches a threshold of stored energy before discharging the stored energy at a particular reservoir station.

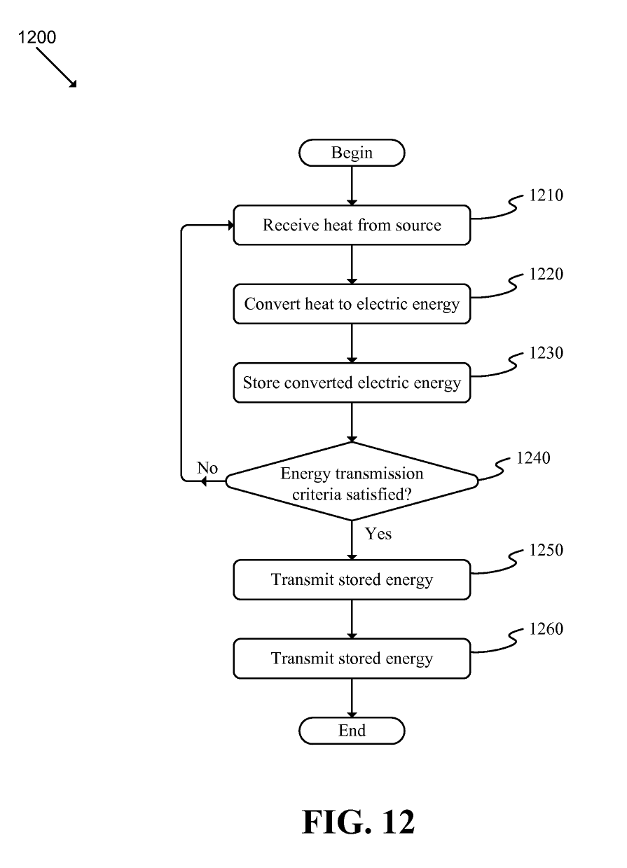

FIG. 12 illustrates a flow chart of a conceptual process 1200 used by some embodiments to control source operation. Such a process may be implemented by a source such as that described above in reference to FIG. 4. The process may begin, for instance, when a source is placed in use (and/or otherwise activated).

As shown, the process may receive (at 1210) heat from a source and convert (at 1220) the heat to electric energy. In some embodiments, the source may include a TEG that generates electric energy based on a difference in temperature between a heat source (e.g., an engine, an exhaust system, etc.) and a “cool” source (i.e., an element that has a lower temperature than the heat source). Such a cool source may include, for instance, a radiator or other cooling element, external air, etc.

Next, the process may store (at 1230) the converted energy. Such energy may be stored in various appropriate ways using various appropriate elements (e.g., one or more batteries, capacitors, etc.).

Process 1200 may then determine (at 1240) whether some energy transmission criteria are satisfied. Such criteria may include, for instance, a minimum threshold of stored energy, a maximum distance to a reservoir, a selection made by a user, etc.

If the process determines (at 1240) that the criteria are not satisfied, the process may repeat operations 1210-1240 until the criteria is satisfied. If the process determines (at 1240) that the criteria are satisfied, the process may transmit 1250 the stored energy such that the energy may be received by a reservoir. In addition, the process may convert (at 1260) the transmitted energy, as necessary (e.g., from DC to AC, from DC to radio frequency/microwave signal, from one voltage level to another, etc.).

One of ordinary skill in the art will recognize that although process 1200 has been described with reference to various specific operations, different embodiments may be implemented in various different ways. For instance, different embodiments may perform the operations in different orders, may include other operations and/or may not perform one or more described operations. As another example, the process may be performed as a set of sub-processes and/or as part of a macro process. As yet another example, the transmission of energy may be interrupted based on various appropriate criteria (e.g., when a source moves outside a receiving range of a reservoir, when a user disconnects a cable, etc.).

B. Reservoir

Various types of reservoirs may implement various specific algorithms during use. For instance, reservoirs placed at intersections may continuously receive energy from any sources within a receiving distance of the reservoir. As another example, reservoirs in rural areas may transmit a beacon signal to alert sources that are within receiving range that their energy may be deposited (and/or that users associated with the sources will receive benefits from transmitting the energy).

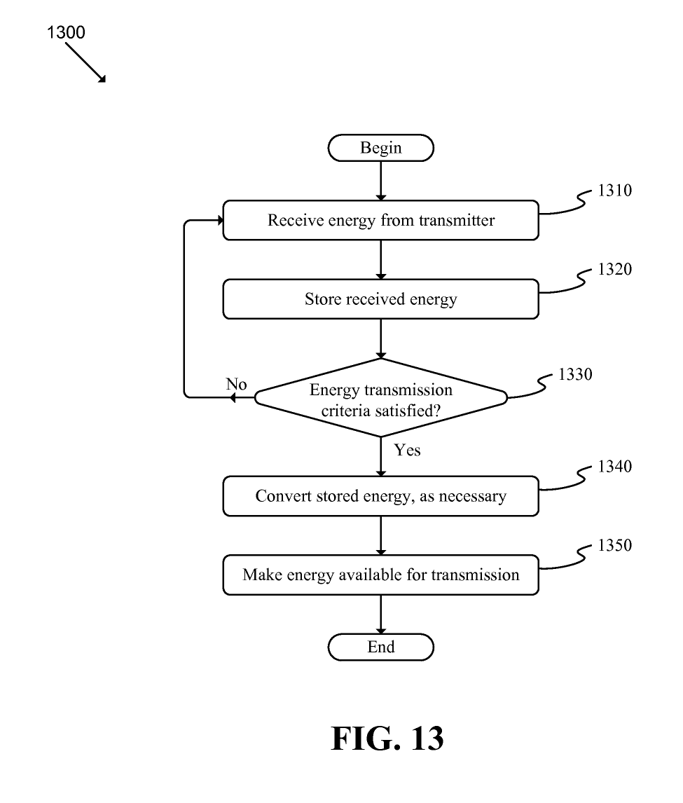

FIG. 13 illustrates a flow chart of a conceptual process 1300 used by some embodiments to control reservoir operation. Such a process may begin, for instance, whenever a reservoir is powered on (and/or otherwise activated). Some embodiments may also interact with one or more sources (not shown). For example, a beacon signal may be sent to sources within a particular range in some embodiments. As another example, the reservoir may be able to communicate with a source and a server such that the source may be associated with a particular user and/or account (e.g., such that the user may receive a financial benefit by transmitting energy, such that any transmitted energy is associated with an existing utility account, etc.).

As shown, the process may receive (at 1310) energy from a transmitter. Such energy may be received using physical and/or software elements such as those described above in reference to FIGS. 4-11. Next, the process may store (at 1320) the received energy. The energy may be stored in various appropriate ways using various appropriate components (e.g., a battery, capacitor, etc.). The process may then determine (at 1330) whether any energy transmission criteria have been satisfied. Such criteria may include various appropriate parameters, thresholds, etc. For instance, energy may be stored locally at a reservoir until a threshold is reach at which point some measure of energy may be made available to a load, grid, etc. As another example, in a local system, energy may be stored indefinitely and only transmitted based on specific usage criteria (e.g., when power from an electric utility is lost, when additional power is needed by a local system, etc.).

If the process determines (at 1330) that the energy transmission criteria are not satisfied, the process may repeat operations 1310-1330, as appropriate. If the process determines (at 1330) that the energy transmission criteria are satisfied, the process may then convert (at 1340) the stored energy, as necessary (e.g., from DC to AC, from DC to radio frequency/microwave signal, from one voltage level to another, etc.). The process may then make (at 1350) the energy available for transmission (e.g., by providing a voltage to a bus or other connection element, by wirelessly transmitting the stored energy, etc.).

One of ordinary skill in the art will recognize that although process 1300 has been described with reference to various specific operations, different embodiments may be implemented in various different ways. For instance, different embodiments may perform the operations in different orders, may include other operations and/or may not perform one or more described operations. As another example, the process may be performed as a set of sub-processes and/or as part of a macro process. As yet another example, the transmission of energy may be interrupted based on various appropriate criteria (e.g., when a source moves outside a receiving range of a reservoir, when a user disconnects a cable, etc.).

C. Server

The server of some embodiments may implement various different processes based on various relevant factors. In some embodiments, the server may actively implement tasks and/or send data to other system elements. In some embodiments, the server may be a passive resource that is accessible by other system elements. Some embodiments may provide a server that allows active, passive, etc. interaction with various types of sources over various appropriate communication pathways.

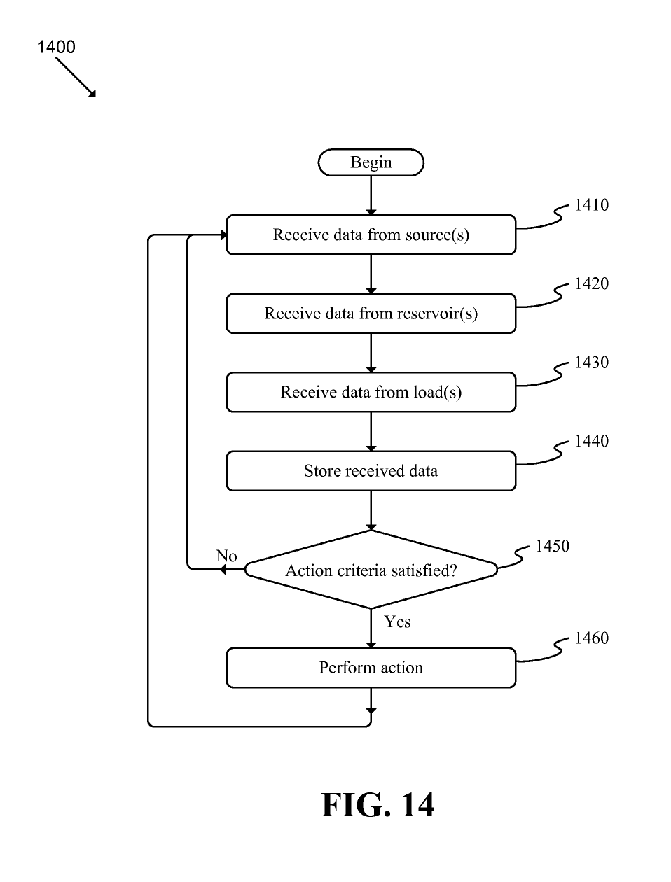

FIG. 14 illustrates a flow chart of a conceptual process 1400 used by some embodiments to monitor and/or control overall system operation. Such a process may begin, for instance, whenever a server device is brought online. As shown, the process may receive (at 1410) data from a set of sources. Such data may include information regarding, for example, location of the source, owner of the source, stored energy accumulated by the source, type of source, etc.

The process may then receive (at 1420) data from a set of reservoirs. Such data may include information regarding, for example, location of the reservoir, stored energy accumulated by the reservoir, sources associated with the reservoir, etc.

Next, process 1400 may receive (at 1430) data from one or more loads. Such data may include power requirements of the load, type of load, etc. The process may then store (at 1440) the received data. Such data may be stored in various appropriate ways (e.g., using one or more databases, distributed across one or more devices, etc.) and may be accessible to various system elements in various appropriate ways (e.g., using a network connection, through an API, etc.).

The process may then determine (at 1450) whether some action criteria have been satisfied. Such action criteria may include various different parameters, thresholds, evaluations, etc. For instance, some embodiments may determine whether a user is entitled to a reward, whether a reservoir and/or source should be activated, etc.

If the process determines (at 1450) that no action criteria have been satisfied, the process may repeat operations 1410-1450. If the process determines (at 1450) that action criteria have been satisfied, the process may perform (at 1460) the action(s) associated with the criteria. Such actions may include, for instance, directing a source to transmit energy, directing a reservoir to provide energy to a load, updating user account information, providing a reward to a user, etc.

One of ordinary skill in the art will recognize that although process 1400 has been described with reference to various specific operations, different embodiments may be implemented in various different ways. For instance, different embodiments may perform the operations in different orders, may include other operations and/or may not perform one or more described operations. As another example, the process may be performed as a set of sub-processes and/or as part of a macro process.

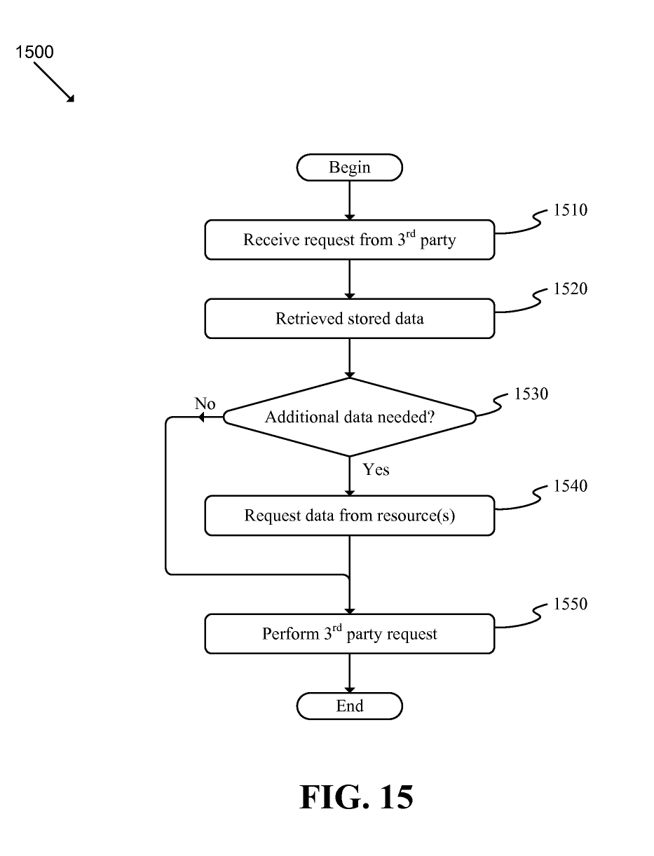

FIG. 15 illustrates a flow chart of a conceptual process 1500 used by some embodiments to allow a third party to interact with the system of some embodiments. Such a process may begin, for instance, when a third party launches a client application provided by some embodiments.

As shown, the process may receive (at 1510) a request from a third party. Such a request may include a request for data (e.g., energy transmitted by a source, energy collected by a reservoir, etc.), a request for action (e.g., directing a source to transmit energy, directing a reservoir to transmit a beacon signal, etc.), and/or other appropriate requests.

The process may then retrieve (at 1520) stored data. Such data may include historical usage data related to a source, reservoir, user, etc., data related to current operating conditions, etc. Next, the process may determine (at 1530) whether additional data is needed. Such a determination may be made based on various appropriate criteria (e.g., amount of data collected, relevance of collected data, etc.).

When the process determines (at 1530) that additional data is needed, the process may request (at 1540) the data from the appropriate resource(s). Alternatively, the process may determine (at 1530) that no additional data is needed. In either case, the process may then perform (at 1550) the third party request. Such performance may include sending various data elements and/or instructions to various other system components (e.g., a source, reservoir, etc.).

One of ordinary skill in the art will recognize that although process 1500 has been described with reference to various specific operations, different embodiments may be implemented in various different ways. For instance, different embodiments may perform the operations in different orders, may include other operations and/or may not perform one or more described operations. As another example, the process may be performed as a set of sub-processes and/or as part of a macro process.

### IV. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

FIG. 16 conceptually illustrates a schematic block diagram of a computer system 1600 with which some embodiments of the invention may be implemented. For example, the system described above in reference to FIG. 1 may be at least partially implemented using computer system 1600. As another example, the processes described in reference to FIGS. 12-15 may be at least partially implemented using sets of instructions that are executed using computer system 1600.

Computer system 1600 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 1600 may include a bus 1605, at least one processing element 1610, a system memory 1615, a read-only memory (“ROM”) 1620, other components (e.g., a graphics processing unit) 1625, input devices 1630, output devices 1635, permanent storage devices 1640, and/or network interfaces 1645. The components of computer system 1600 may be electronic devices that automatically perform operations based on digital and/or analog input signals.

Bus 1605 represents all communication pathways among the elements of computer system 1600. Such pathways may include wired, wireless, optical, and/or other appropriate communication pathways. For example, input devices 1630 and/or output devices 1635 may be coupled to the system 1600 using a wireless connection protocol or system. The processor 1610 may, in order to execute the processes of some embodiments, retrieve instructions to execute and data to process from components such as system memory 1615, ROM 1620, and permanent storage device 1640. Such instructions and data may be passed over bus 1605.

ROM 1620 may store static data and instructions that may be used by processor 1610 and/or other elements of the computer system. Permanent storage device 1640 may be a read-and-write memory device. This device may be a non-volatile memory unit that stores instructions and data even when computer system 1600 is off or unpowered. Permanent storage device 1640 may include a mass-storage device (such as a magnetic or optical disk and its corresponding disk drive).

Computer system 1600 may use a removable storage device and/or a remote storage device as the permanent storage device. System memory 1615 may be a volatile read-and-write memory, such as a random access memory (“RAM”). The system memory may store some of the instructions and data that the processor uses at runtime. The sets of instructions and/or data used to implement some embodiments may be stored in the system memory 1615, the permanent storage device 1640, and/or the read-only memory 1620. For example, the various memory units may include instructions for monitoring stored energy in accordance with some embodiments. Other components 1625 may perform various other functions.

Input devices 1630 may enable a user to communicate information to the computer system and/or manipulate various operations of the system. The input devices may include keyboards, cursor control devices, audio input devices and/or video input devices. Output devices 1635 may include printers, displays, and/or audio devices. Some or all of the input and/or output devices may be wirelessly or optically connected to the computer system.

Finally, as shown in FIG. 16, computer system 1600 may be coupled to a network 1650 through a network interface 1645. For example, computer system 1600 may be coupled to a web server on the Internet such that a web browser executing on computer system 1600 may interact with the web server as a user interacts with an interface that operates in the web browser. In some embodiments, the network interface 1645 may provide one or more application programming interfaces (APIs) that may be adapted to allow third party users to access database information and/or control various aspects of system operation (e.g., discharge of sources, provision of reservoir resources to external loads, etc.).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1600 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

I claim:

1. A system adapted to generate, collect and store electrical energy, the system comprising:
a set of sources; each source in the set adapted to generate heat energy, convert the generated energy into electrical energy, and store the electrical energy; and
a set of reservoirs, each reservoir in the set adapted to receive the stored electrical energy from at least one source in the set of sources and store the received energy.

2. The system of claim 1 further comprising a server adapted to monitor and control each source in the set of sources and each reservoir in the set of reservoirs.

3. The system of claim 1, wherein each source in the set of sources generates heat energy and converts the generated heat energy, using a temperature difference across elements of the source, into electrical energy.

4. The system of claim 3, wherein the heat energy is converted into electrical energy using a thermo-electric generator.

5. The system of claim 1, wherein each source in the set of sources is adapted to transmit the stored electrical energy to at least one reservoir in the form of a microwave signal.

6. The system of claim 5, wherein each reservoir in the set of reservoirs is adapted to receive the microwave signal and convert the received microwave signal into electrical energy.

7. The system of claim 1, wherein the set of sources includes at least one of a motor vehicle, an airplane, a vessel, and an appliance.

8. The system of claim 1, wherein each reservoir in the set of reservoirs is able to provide the received energy to at least one load.

9. A device adapted to convert heat from a source into electrical energy, the device comprising:
a connection to at least two elements of the source, wherein the at least two elements provide a temperature differential;
a thermo-electric generator (TEG) adapted to convert the temperature differential into electrical energy; and
an energy storage module adapted to receive electrical energy from the TEG and store the received energy.

10. The device of claim 9 further comprising an energy transmission module adapted to receive the stored energy from the energy storage module and provide the energy to a reservoir.

11. The device of claim 10, wherein the energy transmission module comprises:
an oscillator adapted to receive the stored energy and generate a periodic output; and
an antenna adapted to receive the periodic output and propagate a transmitted signal.

12. The device of claim 11, wherein the transmitted signal is a microwave signal.

13. The device of claim 9, wherein the energy transmission module comprises a wired connector adapted to be directly coupled to the reservoir.

14. The device of claim 9, wherein the energy transmission module comprises an inductive coupler.

15. The device of claim 9, wherein the energy transmission module comprises a resonant coupling interface.

16. The device of claim 9 further comprising a communication module adapted to communicate among a set of reservoirs and at least one server.

17. A device adapted to receive transmitted electrical energy from a set of sources, the device comprising:
a receiver array adapted to receive the transmitted electrical energy from at least one source in the set of sources; and
an energy storage element adapted to store the electrical energy received by the receiver array.

18. The device of claim 17, wherein the receiver array comprises a set of receivers, each receiver in the set comprising:
an antenna adapted to receive the transmitted energy and convert the energy into an electrical signal; and
a rectifier adapted to rectify the electrical signal.

19. The device of claim 17 further comprising a low-pass filter adapted to filter the rectified electrical signal.

20. The device of claim 17 further comprising:
at least one of a voltage regulator, converter, and inverter; and
a communication module adapted to communicate among the set of sources and at least one server.
